(19) United States
(12) Patent Application Publication
(10) Pub. No.: US 2012/0068969 A1
(43) Pub. Date: Mar. 22, 2012

(54) METHOD FOR DETERMINING MULTIPLE TOUCH INPUTS ON A RESISTIVE TOUCH SCREEN AND A MULTIPLE TOUCH CONTROLLER

(76) Inventors: Matteo Paolo Bogana, Cerano (NO) (IT); Andrea Celani, Castel di Lama (AP) (IT); Nicolò Pastore, Pero(MI) (IT)

(21) Appl. No.: 13/322,684

(22) PCT Filed: May 29, 2009
(86) PCT No.: PCT/IT09/00238

§ 371 Date: Nov. 28, 2011

(51) Int. Cl. G06F 3/045

(52) U.S. Cl. 345/174

(57) ABSTRACT

The present invention relates to a method and a Multi-Touch controller for determining multiple touch inputs on a resistive touch screen, such screen having a first layer (2A) and a second layer (2B) with a first axis (2C) and a second axis (2D) orthogonal to each other being definable thereat, and wherein said first layer is designed to be touched. Particularly, the method includes the steps of touching the first layer (2A) at a first point (P1), while also touching said first layer (2A) at a second point (P2), determining the coordinates of a midpoint (POx, POy) relative to the coordinates of said first point (P1) and said second point (P2). It also includes the steps of powering the first layer (2A) with a voltage value (Vcc), while said first layer (2A) is touched at said first point (P1) and said second point (P2) respectively; detecting a first value of current (I2;X) circulating in said first layer (2A), when the latter is powered with said predetermined voltage value (Vcc); processing said first current value (1̂x) to determine a first value (Δx) of the coordinate difference along an axis (2C) of the first layer (2A) between the coordinates of said first touch point (P1) and said second touch point (P2); processing said first value (Δx) and the coordinates of said midpoint (P0x,P0y) to determine the coordinates of said first touch point (P1) and said second touch point (P2) along said axis (2C) of the first layer (2A).

### TECHNICAL FIELD

The present invention relates to a method and a controller for determining multiple touch inputs on a resistive touch screen and particularly, but without limitation, for determining the coordinates of two touch points as defined in the preambles of claims 1 and 16 respectively.

### BACKGROUND ART

Resistive touch screens are among the most important and widespread display devices, due to their low cost, and to their high flexibility and reliability.

Touch screens have found application in a variety of electronic apparatus such as ATMs (Automated Teller Machines), kiosks, POS (Points of Service) apparatus, but especially in electronic devices such as PDAs (Personal Digital Assistants), mobile phones, notebooks, laptops, MP3 readers, etc.

These touch screens have a flexible upper layer and a rigid lower layer parallel each other and separated by insulating means, in which the inner surface of each layer is coated with a transparent metal-oxide layer.

By pressing the upper flexible layer by the finger of one hand or an object, electric contact is created between the resistive layers, essentially due to closure of a circuit switch.

The control electronics of the screen alternates the power supply voltage between the layers to obtain the x coordinate and the y coordinate of the point at which the touch has occurred.

Nevertheless, resistive touch screens as described above suffer from severe drawbacks when used with a multiple touch feature.

When a user touches the screen (i.e. the flexible upper layer) at a first point and at a second point while the screen is still touched at the first point, the upper layer contacts the lower layer at two points, i.e. at first and second touch points.

In this case, instead of returning the x, y coordinates of both the first and second points, the control electronics provides the x, y coordinates of a midpoint between the positions of the first touch point and the second touch point.

Therefore, the electronics does not return the coordinates of each touch point, but generates the coordinates of a single point intermediate between the touch points.

### TECHNICAL PROBLEM

Therefore, the need is highly felt for detection of multiple touch inputs in resistive touch screens to implement features that might not otherwise find application in a common resistive touch screen.

Hence, the present invention is based on the problem of providing a method and a controller that have such functional features as to fulfill the above need, while obviating the above prior art drawbacks.

### TECHNICAL SOLUTION

This problem is solved by a method for determining multiple touch inputs on a resistive touch screen as defined in claim 1.

Furthermore, this problem is also solved by a multiple touch controller as defined in claim 16.

### ADVANTAGEOUS EFFECTS

With the present invention, a method is provided for determining the coordinates of each touch point without changing the control electronics of a common resistive touch screen, such as of the 4-wire, 5-wire or 8-wire screen.

Furthermore, with the present invention, a Multi-Touch controller may be provided, either in discrete or in integrated form, which can determine the coordinates of each touch point.

Also, with the present invention, currently available 4-wire, 5-wire or 8-wire screens, with which the Multi-Touch controller is connected, need not be changed.

Finally, the present invention allows determination of the value of the pressure exerted on the touch screen at the touch point.

### BRIEF DESCRIPTION OF THE DRAWINGS

Further features and advantages of the method of the present invention will result from the following description of one preferred embodiment thereof, which is given by way of illustration and without limitation with reference to the accompanying figures, in which:

FIGS. 1A and 1B show a circuit model representing a resistive touch screen when it is touched at one point and at two points respectively;

FIG. 2 is a diagrammatic view of the panel when it is touched at two points with the coordinates of the points being determined along an axis, according to the present invention;

FIG. 3 is the same diagrammatic view as the panel of FIG. 2, with the coordinates of the points being determined along another axis, according to the present invention;

FIG. 4 is a circuit diagram of the Multi-Touch controller for determining the coordinates of the two touch points as shown in FIGS. 2 and 3, according to the present invention;

FIG. 5 shows a first possible embodiment of a device corresponding to the circuit diagram of FIG. 4, according to the present invention;

FIG. 6 shows another embodiment of a device corresponding to the circuit diagram of FIG. 4, according to the present invention.

### DETAILED DESCRIPTION

As is known to those skilled in the art, if pressure is exerted on a resistive touch screen by a finger or a pen, contact is generated at one point between the outer flexible layer and the underlying rigid layer.

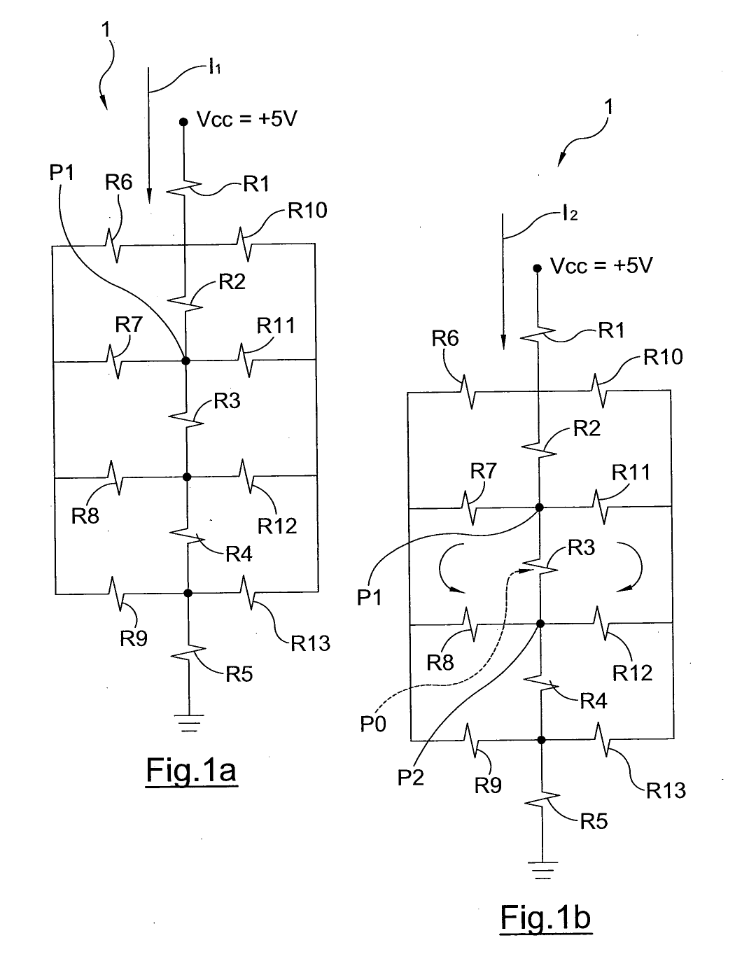

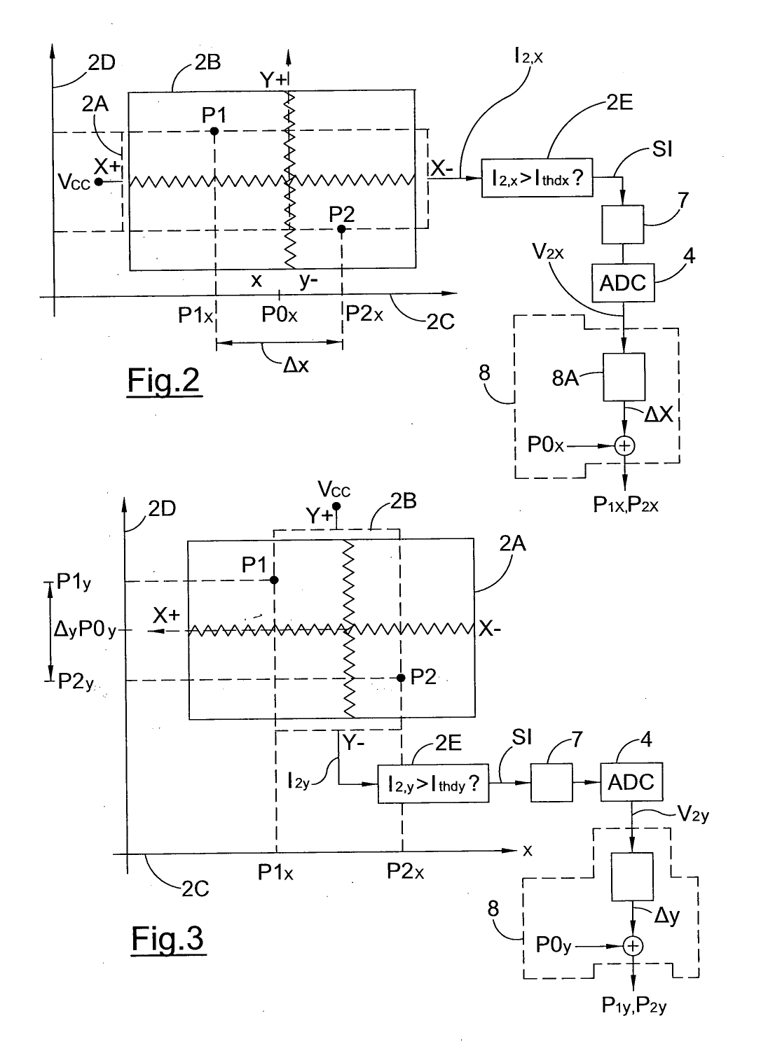

In this condition, the control circuit, also referring to FIG. 1A, which shows a circuit model representing a resistive touch screen to obtain the Cartesian coordinates x, y of a single touch point P1, provides alternate power supply to the two screen layers, e.g. with a supply voltage VCC of 5V.

Each of these layers can represent a physical axis, one axis for the x coordinate and the other for the y coordinate. The control circuitry, which also includes an ADC reads the potential drop at each layer and interprets such potential drop value of each layer by determining the x, y coordinate values at the touch point P1.

Therefore, the control circuitry is able to read a voltage value and process it to generate the coordinates x, y of the touch point P1.

Particularly in FIG. 1A, a state is shown in which one of the two screen layers is powered and the other is kept floating; therefore the layer supplied with the voltage Vcc is, for instance, the layer representative of the y coordinates whereas the layer that is kept floating is, for instance, the one representative of the x coordinates.

By (high impedance) voltage reading at the node Vsense by the control circuitry of the screen, the voltage of the touch point P1 may be determined, because no voltage drop occurs at the resistors R10, R11, R12 and R13, so that the y coordinate of the point P1 may be identified.

Therefore, the voltage Vsense will be:

$$Vsense = \frac{5 V}{( R 1 + R 2 + R 3 + R 4 + R 5 )} * ( R 3 + R 4 + R 5 )$$

The same applies to the x coordinate of the point P1, i.e. the voltage Vcc is supplied to the layer that was previously floating, and the layer that was previously supplied with the voltage Vcc is kept floating.

It shall be noted that the current I1 that flows in the powered layer (regardless of whether it is the first or second layer) is constant and only depends on the resistivity of the material of the powered layer and on the value of the supply voltage Vcc.

Referring now to FIG. 1B, in which another contact point P2 is introduced (multiple touch), having for simplicity an x coordinate equal to the one of the touch point P1, the inventors have found that the current I2 that flows in the powered layer (namely in the case of FIG. 1B the layer representative of the y coordinate) increases relative to the one of the single touch point.

This is because by touching the first screen layer at two points, a parallel path is introduced in the lower panel, i.e. the second layer, here representing the x coordinate.

Particularly, current also flows through the links defined by the resistors R11, R12, R3 and the resistors R7, R8 and R3 respectively.

Therefore, when the screen is touched at two points, the voltage Vsense changes with respect to what has been described with reference to FIG. 1A, and takes a value intermediate between the voltage value of the node representative of the contact point P1 and the voltage value of the node representative of the contact point P2.

This is as if the screen were touched at one point P0 located in the middle between the contact points P1 and P2.

Therefore, the current I2 that circulates in the powered layer is higher than the current I1 that flows in the same layer when the panel is touched at one point, and particularly the circulating current in the two-touch point case is:

$$I 2 = \frac{Vcc}{( R 3 // ( R 7 + R 8 ) // ( R 11 + R 12 ) ) + R 1 + R 2 + R 4 + R 5}$$

The current that circulates in the powered layer increases in proportion to the distance between the contact points P1 and P2; the voltage Vsense is the same while the current that circulates in the powered layer is higher than:
both the current that flows in the same layer when the panel is touched at two touch points close to each other,
and the current I1 that flows in the same layer when the panel is touched at one touch point only.

In view of the above, the method for determining multiple touch inputs on a resistive touch screen having a first layer 2A defining a first axis 2C and a second layer 2B defining a second axis 2D, said first axis 2C and said second layer 2B being orthogonal to each other, comprises the steps of:
touching the first layer 2A at a first point P1, while also touching said first layer 2A at a second point P2;
determining the coordinates of a midpoint POx, POy relative to the coordinates of the first point P1 and the second point P2.

The steps of determining the coordinates of the midpoint POx, POy may be carried out as previously described with respect to FIG. 1B, and is thus deemed to be known.

For simplicity, but without prejudice to the general scope of the invention, it is assumed hereinafter that the first layer 2A is the flexible outer layer, i.e. the one that is typically touched during screen operation, the second layer 2B is the rigid inner layer, parallel to the first layer 2A and the first layer and the second layer having the same area.

Considering the above assumptions, the method advantageously comprises the steps of:
powering the first layer 2A (e.g. the flexible outer layer) with a voltage value Vcc, while such first layer 2A is touched at the first point P1 and the second point P2 respectively;
detecting a first value of current I_{2,x} circulating in the first layer 2A, i.e. the layer powered with the voltage value Vcc;
processing the first current value I_{2,x} to determine a first modulus value Δx representative of the coordinate difference along the axis 2C (e.g. the x axis) of the first layer 2A between the coordinates of the first touch point P1 and the second touch point P2;
processing the first value Δx and the coordinates of said midpoint P0x,P0y to determine the coordinates of the first touch point P1 and the second touch point P2 along the axis 2C of the first layer 2A.

Particularly, also referring to FIG. 3, which shows the first layer 2A and the second layer 2B of the resistive touch screen with different areas, but only for simplicity of graphical representation, and assuming that the layer powered with the voltage Vcc is the first layer 2A, i.e. the one that represents the x coordinate of the touch points P1 and P2, then the method comprises the steps of reading the current I_{2,x} that flows in the first layer 2A and processing such current value I_{2,x} to calculate the first modulus value Δx.

Such value Δx is representative of the coordinate difference along the x axis of the first layer 2A between the x coordinates of the point P1 and the point P2.

It shall be noted that the method also comprises the step of checking whether such current value I_{2,x} is higher than a first predetermined current threshold I_{thdx}.

Particularly, in the method, the current value I_{2,x} is compared with the predetermined current threshold I_{thdx}, which can be equal to the value of the current that circulates in the first powered layer 2A, when such first layer 2A is touched at one point only.

In other words, the checking step determines by comparison whether the current value I_{2,x} is higher than the current threshold I_{thdx} which can be equal to the current value I1.

If this condition is met (Yes branch of the decision block 2E), it is advantageously possible to ascertain that the touch screen has been touched at a first point P1 and at a second point P2 while the first point P1 was still touched.

As described above, with this method, the first current value I_{2,x} is processed to calculate the first modulus value Δx, i.e. the distance between the x coordinates of the points P1 e P2.

Such processing is preferably carried out by a step in which the first current value I_{2,x} is compared with a first plurality of predetermined values.

Each value of said plurality of values may stand for a coordinate difference along one axis between the coordinates of the first touch point P1 and the second touch point P2.

Namely, considering the above conditions, each value of this plurality of values may stand for the distance Δx along the x axis of the first layer between the coordinates of the first touch point P1 and the second touch point P2.

In other words, with prior knowledge of certain physical characteristics, such as the resistivity of the layers, or the non-linearity characteristics associated with the implementations of the electronics, etc., a data table 8A, also known as look up table, may be advantageously implemented, in which a first plurality of values may be entered.

Such first plurality identifies the electrical conduction value of the first layer, thereby directly providing the first modulus value Δx, i.e. the distance along the x axis of the first layer 2A between the coordinates of the first touch point P1 and the second touch point P2.

As an alternative to the coordinate difference between the coordinates of the first touch point P1 and the second touch point P2, i.e. the first value Δx, the value Δx/2 may be directly associated with this plurality of predetermined values.

Therefore, by reading the value of the current I_{2,x} that flows in the layer 2A when the latter is touched at two points P1 and P2 and by previously determining at the factory or by a calibration process the electrical conduction value that the first layer 2A shall have when contacted at said two touch points P1 and P2, one of those predetermined values may be associated with the current value I_{2,x} that has been read, to obtain the spacing between the x coordinates of the points P1 and P2, i.e. the first modulus value Δx.

Otherwise, the step of processing said first current value I_{2,x} to calculate the first modulus value Δx may be implemented with a plurality of degrees of the following function:

Δx=a_{n,x}*I_{2,x}ⁿ+a_{n-1,x}*I_{2,x}ⁿ⁻¹+a_{n-2,x}*I_{2,x}ⁿ⁻²+ . . . +a_{1,x}*I_{2,x}+a_{0,x}

where a_{n,x}, . . . , a_{0,x} represent the physical, circuit and non-linearity parameters of the first layer 2A, whereas I_{2,x}ⁿ, . . . , I_{2,x} represent n-th powers of the current I_{2,x} circulating in said first layer 2A.

Once the modulus value Δx has been obtained, with the x, y coordinates of the midpoint P0 being known, the x coordinates of the two points P1 and P2 may be determined.

Considering that the coordinates of the midpoint P0 are returned by the control circuitry of any resistive touch screen whenever it is contacted at two points, and considering the possibility of reading the current that flows in the layer supplied with the voltage Vcc, as explained in greater detail hereinafter, the method provides the coordinates of each of the two touch points P1 and P2 along an axis of the screen by processing that current value I_{2,x} to obtain the spacing Δx between the two touch points P1 and P2.

For instance, by addition or subtraction of such first modulus value Δx to or from the x, y coordinates of the midpoint P0, the x coordinates of the two points P1 and P2 may be determined.

Thus, in a preferred embodiment, the x coordinates of the two points P1 and P2 may be obtained from the following relations:

P1_{X}=P0ₓ−Δx/2 (1)

and

P2_{X}=P0_{X}−Δx/2 (2)

Particularly, using the first modulus value Δx, half of this value has been added or subtracted to/from the x coordinate value of the midpoint P0.

In a preferred embodiment, the step of comparing the first current value I_{2,x} with a plurality of predetermined values also comprises the additional steps of:
converting the first current value I_{2,x} into a corresponding voltage value V_{2,x};
processing said voltage value V_{2,x} to generate the coordinate difference Δx between the coordinates of the first touch point P1 and the second touch point P2.

Once the x coordinates of the two touch points P1 and P2 have been obtained, the y coordinates of the same touch points P1 and P2 may be also obtained by analogy.

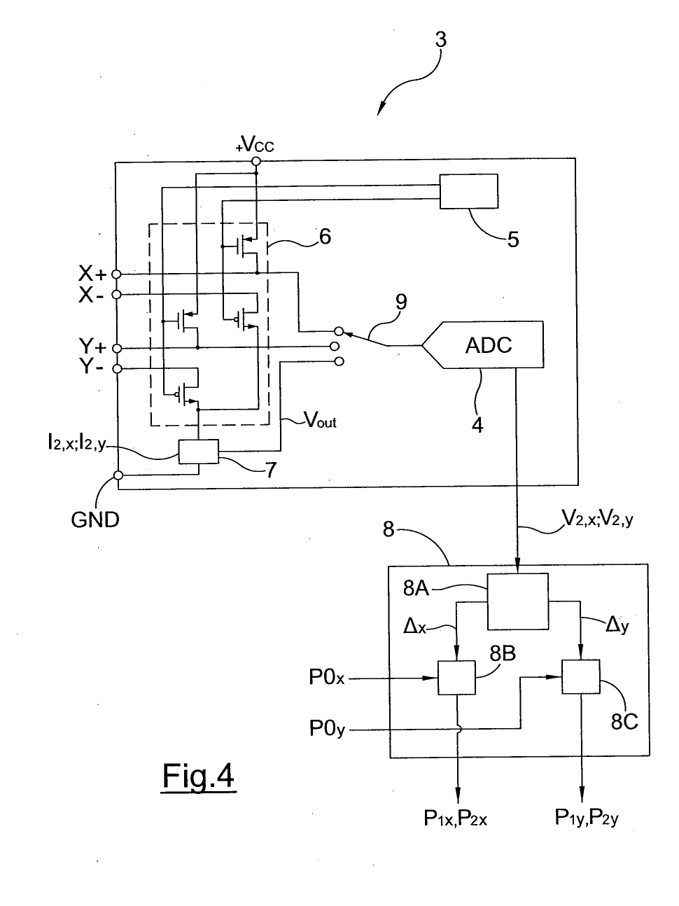

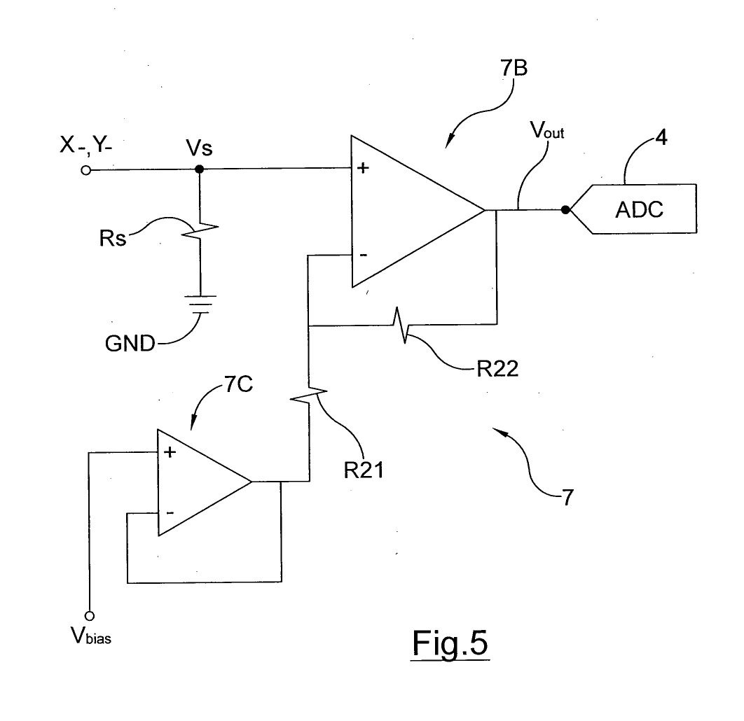

Particularly, referring to FIG. 4, still considering the above assumptions, in order to obtain the second value Δy, i.e. the modulus spacing between the y coordinates of the touch points P1 and P2 along an axis 2D of the second layer 2B (e.g. the rigid lower layer), such axis 2D being orthogonal to the axis 2C of the first layer 2A, the method comprises the steps of:
powering the second layer 2B (e.g. the one representative of the y coordinates) with a voltage value Vcc, while the first layer 2A (e.g. the one representative of the x coordinates) is touched at the first point P1 and the second point P2 respectively;
detecting a second value of current I_{2,y} circulating in the second layer 2B, when the latter is powered with the voltage value Vcc;
processing the second detected current value I_{2,y} to calculate the second modulus value Δy that represents the coordinate difference of the distance between the coordinates of said first touch point P1 and said second touch point P2, said coordinate difference being calculated along an axis 2D of the second layer, which is orthogonal to the axis 2C of the first layer 2A;
processing said second modulus value Δy and the coordinates of the midpoint P0 to determine the coordinates of the first touch point P1 and the second touch point P2 along said second axis 2D.

Based on the above assumptions and through the above described method steps, a second value Δy may be determined, i.e. the coordinate spacing between the first point P1 and the second point P2 along the y axis.

The other steps of the method for determining the second value Δy (i.e. the spacing along the y axis between the coordinates of the first point P1 and the second point P2) are directly and uniquely deducted from the steps described above for determining the first value Δx (i.e. the spacing between the coordinates of the first point P1 and the second point P2 along the x axis).

Therefore, by reading the value of the current I_{2,y} that flows in the second layer 2B when the latter is touched at two points P1 and P2 and by previously determining at the factory or by a calibration process the electrical conduction value that such second layer 2B shall have when contacted at said two touch points P1 and P2, one of those predetermined values may be associated with the current value I_{2,y} that has been read, to obtain the spacing between the y coordinates of the points P1 and P2, i.e. the second modulus value Δy.

Otherwise, the step of processing the second current value I_{2,y} to calculate the second modulus value Δy may be implemented with a plurality of degrees of the following function:

Δy=a_{n,y}*I_{2,y}ⁿ+a_{n-1,y}*I_{2,y}ⁿ⁻¹+a_{n-2,y}*I_{2,y}ⁿ⁻²+ . . . +a_{1,y}*I_{2,y}+a_{0,y}

where a_{n,y}, . . . , a_{0,y} represent the physical, circuit and non-linearity parameters of the second layer 2B, whereas I_{2,y}ⁿ, . . . , I_{2,y} represent n-th powers of the current I_{2,y} circulating in said second layer 2B.

In a preferred embodiment, the step of comparing the second current value I_{2,y} with a second plurality of predetermined values comprises the steps of:
converting the second current value I_{2,y} into a corresponding voltage value V_{2,y};
processing said voltage value V_{2,y} to generate the coordinate difference Δy between the coordinates of the first touch point P1 and the second touch point P2 along said axis of the second layer, which is orthogonal to said axis of the first layer.

Referring now to FIG. 4, there is shown a diagram 3 for the implementation of a Multi-Touch controller for a resistive touch screen, e.g. of the 4-wire type.

Such FIG. 4 shows:
a plurality of resistance lines X+, X−, Y+, Y− of a touch screen, here four lines,
a power supply line for the value Vcc and
a fixed potential point GND.

The diagram 3 of the Multi-Touch controller further includes:
an analog-to-digital converter (ADC) 4,
a driver stage 6, known per se and not further described herein, for driving the above mentioned resistance lines X+, X−, Y+, Y− of the touch screen,
a logic section 5 for supervising the operation of the driver stage 6, and
a current reading device 7.

Advantageously, the current reading device 7 is operably connected between the driver stage 6 and the fixed potential point GND, such as the ground line or a fixed potential line.

The current reading device 7 is in signal communication with the Analog-to-Digital converter (ADC) 4.

Furthermore, the diagram 3 of the Multi-Touch controller also comprises a processing block 8 that can receive the values from the output of the Analog-to-Digital converter (ADC) 4 and the coordinates of the midpoint P0 for processing them and generating the values representative of the x, y coordinates of the two touch points P1 and P2.

It shall be noted that, in this particular embodiment, the Analog-to-Digital converter (ADC) 4 is, for instance, operably connected to the outputs of the driver stage 6 via a selector 9 that can select the output line having to value to be converted into a digital format.

The current reading device 7 is designed to receive the first current value I_{2,x} and/or the second current value I_{2,y} of the currents that circulate in the layers of the screen.

Preferably, the current reading device 7 is a current-to-voltage converter.

In this case, the Analog-to-Digital converter (ADC) 4 digitizes the signal once it has been converted by the current-to-voltage converter. Particularly, the Analog-to-Digital converter (ADC) 4 has at its output the digital version of the voltage equivalent V_{2,x}, V_{2,y} of the first current value I_{2,x} and/or the second current value I_{2,y}.

The processing block 8 includes a table 8A which stores electrical conduction values for the first 2A and/or second 2B layers, for instance in the form of data vectors.

In other words, the table 8A stores the values that account for the physical and/or electrical features of the screen and the control circuitry, to define the first value Δx and/or the second value Δy, i.e. the distance along the x axis of the first layer 2A and along the y axis of the second layer 2B between the coordinates of the first touch point P1 and the second touch point P2 along the x axis of the first layer 2A and along the y axis of the second layer 2B.

It shall be noted that, instead of the first value Δx and/or the second value Δy, the tale 8A may store the value Δx/2 and/or the value Δy/2.

The processing block 8 also receives at its input the x, y coordinates of the midpoint P0, e.g. generated by coordinate generator means (known per se and not described and illustrated herein).

Using these x, y coordinates of the midpoint P0, the x, y coordinates of the points P1 and/or P2 may be determined through a summer node 8B, 8C.

Particularly, the processing block comprises two summer nodes 8B, 8C that must be appropriately configured for performing addition and/or subtraction of the value of said first value Δx and/or second value Δy to/from the x,y coordinates of the midpoint P0.

Referring to FIG. 5, there is shown a first embodiment of the current reading device 7 implemented as a low-side current-to-voltage converter.

The low side current-to-voltage converter comprises a non-inverting amplifier 7B and a voltage buffer 7C.

The non-inverting terminal of the amplifier 7B is connected to the output of the screen via a resistor Rs, whereas the output of the amplifier 7B is connected to the input of the ADC converter 4. The feedback of the amplifier 7B has a feedback resistor R22.

The non-inverting input of the voltage buffer 7C is set at a bias voltage Vbias and its output is connected to the feedback of the non-inverting amplifier 7B through a resistor R21.

The resistor Rs has both a terminal connected to the non-inverting terminal of the amplifier 7B and a terminal connected to the fixed-potential point GND, such as the ground.

The current I_{2,x} or I_{2,y} circulates in the first layer 2A or second layer 2B respectively, powered with the voltage Vcc, and reaches the positive terminal of the non-inverting amplifier 7B and the fixed-potential point GND.

Particularly, the resistor Rs is selected of low resistance value, such as a few ohms, i.e. negligible with respect to the panel resistance. This will minimize the errors caused by its presence in the classical single touch reading diagram.

Therefore, the voltage Vs that falls onto the resistor Rs is amplified and subtracted by an offset that can be set with the voltage Vbias.

At the input of the ADC converter 4, there is a voltage of:

$$Vout = I * Rs * ( 1 + \frac{R 22}{R 21} ) - Vbias * ( \frac{R 22}{R 11} )$$

where I is I_{2,x} or I_{2,y} respectively and (1+R22/R21) is the gain of the non-inverting amplifier 7B.

Thus, the voltage value Vout at the output of the current reading device 7 and at the input of the analog-to-digital converter 4, represents the current value I_{2,x} or I_{2,y} being read respectively.

It shall be noted, that in the particular circuit implementation of FIG. 5, the non-inverting amplifier 7B is connected with the resistance lines X−, Y−, because these lines, in the classical single-touch circuit diagram, are connected to the ground, which is usually the most negative point of the circuit.

The circuit of FIG. 5 may also operate in opposite mode, i.e. by connecting the resistance lines X−, Y− to the power supply line Vcc.

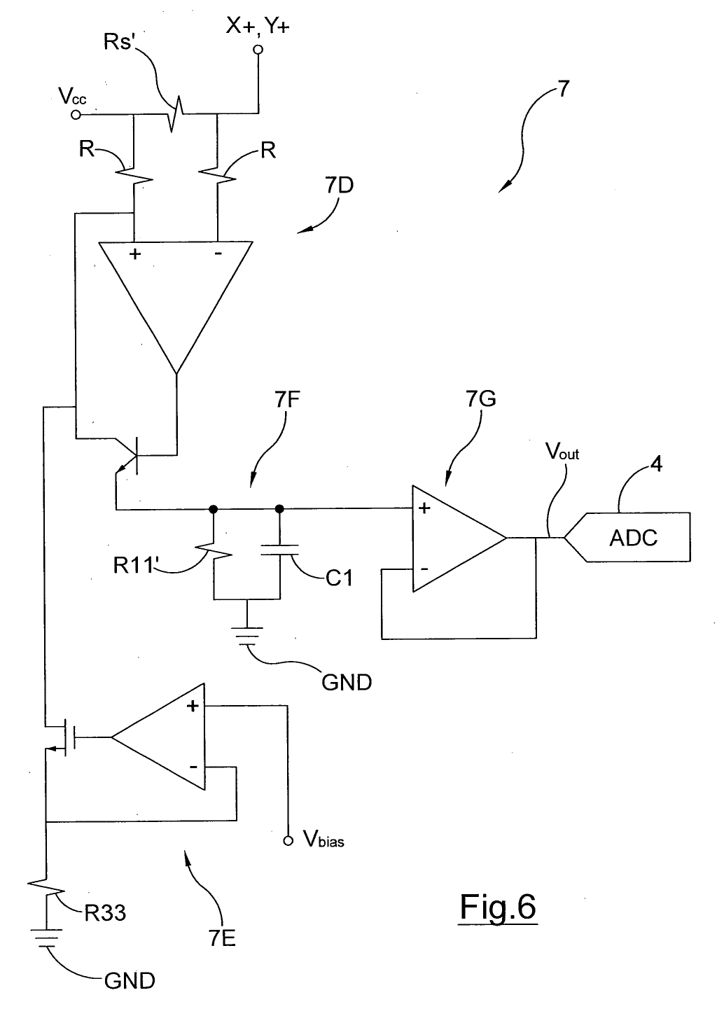

Referring to FIG. 6, there is shown a second embodiment of the current reading device 7 implemented as a high-side current-to-voltage converter.

The high side current-to-voltage converter comprises a non-inverting amplifier 7D, a current generator 7E, a filter 7F and a voltage buffer 7G.

The current that circulates in the powered first layer 2A or second layer 2B (i.e. I_{2,x} or I_{2,y}) also flows in the Rs'. Particularly, the resistor Rs' is selected of low resistance value, such as a few ohms, i.e. negligible with respect to the panel resistance. This will minimize the errors caused by its presence in the classical single touch reading diagram.

The voltage Vs that falls onto the resistor Rs' is transferred to the resistor R for the non-inverting node of the non-inverting amplifier 7D due to the feedback line of the non-inverting amplifier 7D. The voltage Vs at the ends of R causes a current Is=Vs/R to flow into the transistor MOS placed in the feedback line of the non-inverting amplifier 7D.

The current Is flows into the filter 7F, which consists of the parallel connection of a resistor R33 and a capacitor C1, so that the output of the buffer 7G has the following output voltage:

$${Vout}^{′} = I * ( R {11}^{′} // ( \frac{1}{s * C 1} ) )$$

The current generator 7E is controlled by the bias voltage Vbias and the output current Iout is used to regulate the offset of the buffer 7G.

### Particularly, Iout is:

Iout=Vbias/R33

Therefore, the output voltage Vout from the buffer 7G, i.e. the reading device is:

$$Vout = ( I * \frac{{Rs}^{′}}{R} ) - ( Vbias * \frac{1}{R 33} ) * ( R {11}^{′} // \frac{1}{s * C 1} )$$

where I is the current being read I_{2,x} or I_{2,y} respectively.

Thus, the voltage value Vout at the output of the current reading device 7 and at the input of the analog-to-digital converter 4, represents the current value I_{2,x} or I_{2,y} being read respectively.

The advantages of the embodiment of the current reading device 7 of FIG. 6 over that shown in FIG. 5 consist in that the panel ground does not have to be displaced relative to the current reading device to read the current I_{2,x} o I_{2,y}.

It shall be noted that the low-side and high side circuits may be designed to operate with resistive touch screens even when such screens are implemented in 5-wire or 8-wire configurations.

Otherwise, the current reading device 7 may be integrated in a current ADC.

In other solutions, the current reading device 7 may be implemented by:
a current-to-frequency converter, in which the currents I_{2,x} and/or I_{2,y} being read are transferred to an astable multivibrator. The waveform that comes out of the astable multivibrator will have a frequency proportional to the current received. Using a timer, the waveform period may be acquired by digitizing the current without an ADC proper;
a current/charge-->charge-voltage converter in which the current I_{2,x} and/or I_{2,y} being read for a given time (charge) in a capacitor that converts the charge into voltage, which is digitized by a common ADC;
a current/light-->light/current-->current/voltage converter that allows full electrical insulation between the electronic current reading section and the electronic section to be read.

The Multi-Touch controller 3 may be integrated in microcontrollers, microprocessors, On-Board circuits, etc., or may be developed through the use of digital ports and analog ports of the most widespread of currently available processors and microprocessors.

In an alternative embodiment, the table 8A may store an additional plurality of values that represent the value of pressure exerted at a touch point.

The inventors have found that the current circulating in the layers 2A, 2B of the screen when they are powered with the power supply voltage Vcc, changes according to the touch area or zone of the flexible screen surface.

Thus, by pressing the finger with lower force, the area is very small, whereas as touch pressure is increased, the area reaches its maximum. This area difference generates a current difference corresponding to the two touches.

Therefore, the current I_{2,x} and/or I_{2,y} may vary from a current I0ₘᵢₙ, the absorption current of the screen when powered in idle condition or with a single touch at minimum force (negligible area) and the maximum current I0ₘₐₓ generated by the maximum touch area of a single touch.

Given the end currents, i.e. I0ₘᵢₙ and I0ₘₐₓ within which the screen may change during its operation, and all the intermediate values, these may be stored in the table 8A.

With the above method, the value of pressure exerted at least at one touch point P1 or P2 may be obtained in a step in which the values of the currents I_{2,x} and I_{2,y} being detected are processed, and later modified according to the values stored in the table 8A.

As clearly shown in the above description, the method and controller of the invention fulfill the above mentioned need and also obviate the prior art drawbacks as set out in the introduction of this disclosure.

Those skilled in the art will obviously appreciate that a number of changes and variants may be made to the method and controller as described hereinbefore, without departure from the scope of the invention, as defined in the following claims.

1. A method for determining multiple touch inputs on a resistive touch screen, such screen having a first layer (2A) defining a first axis (2C) and a second layer (2B) defining a second axis (2D), said first axis (2C) and said second layer (2B) being orthogonal to each other, and wherein said first layer is designed to be touched, the method including the steps of:
touching the first layer (2A) at a first point (P1), while also touching said first layer (2A) at a second point (P2);
determining the coordinates of a midpoint (P0x, P0y) relative to the coordinates of said first point (P1) and said second point (P2);
characterized in that it comprises the steps of:
powering the first layer (2A) with a voltage value (Vcc), while said first layer (2A) is touched at said first point (P1) and said second point (P2) respectively;
detecting a first value of current (I_{2,x}) circulating in said first layer (2A), when the latter is powered with said voltage value (Vcc);
processing said first current value (I_{2,x}) to determine a first value (Δx) of the coordinate difference along an axis (2C) of the first layer (2A) between the coordinates of said first touch point (P1) and said second touch point (P2);
processing said first value (Δx) and the coordinates of said midpoint (P0x,P0y) to determine the coordinates of said first touch point (P1) and said second touch point (P2) along said axis (2C) of the first layer (2A).

2. A method as claimed in claim 1, also including the step of checking whether said first current value (I_{2,x}) that has been detected is higher than a first predetermined current threshold (I_{thdx})

3. A method as claimed in claim 2, wherein said first threshold (I_{thdx}) is equal to the value of the current that circulates in said first layer (2A), when said first layer (2A) is touched at said first point (P1) or second point (P2) only.

4. A method as claimed in claim 1, wherein said step of processing said first current value (I_{2,x}) to determine the first modulus value comprises:
comparing said first current value (I_{2,x}) with a first plurality of predetermined values, each representing a coordinate difference of the distance between the coordinates of said first point (P1) and second point (P2) along said first axis (2C) of the first layer (2A).

5. A method as claimed in claim 4, wherein the step of comparing the first current value (I_{2,x}) with a first plurality of predetermined values comprises the steps of:
converting the first current value (I_{2,x}) into a corresponding voltage value (V_{2,x});
processing said voltage value (V_{2,x}) to generate the coordinate difference (Δx) between the coordinates of the first point (P1) and the second point (P2) along said axis of the first layer (2A).

6. A method as claimed in claim 4, wherein said step of processing said first value (Δx) and the coordinates of said midpoint (P0x,P0y) to determine the coordinates of said first touch point (P1) and said second touch point (P2) along said first axis (2C) of the first layer (2A) comprises the step of:
adding or subtracting said first value (Δx) to/from the coordinates of said midpoint (P0x,P0y) to determine the coordinates of said first touch point (P1) and said second touch point (P2) along said first axis (2C) of the first layer (2A).

7. A method as claimed in claim 1, wherein said step of processing said first current value to determine the first modulus value (Δx) comprises the application of the following formula
Δx=a_{n,x}*Iⁿ_{2,x}+a_{n-1,x}*Iⁿ⁻¹_{2,x}+a_{n-2,x}*I_{2,x}ⁿ⁻²+ . . . +a_{1,x}*I_{2,x}+a_{0,x}
where a_{n,x}, . . . , a_{0,x} represent the physical, circuit and non-linearity parameters of the first layer (2A), whereas Iⁿ_{2,x}, . . . , I_{2,x} represent n-th powers of said first value of current (I_{2,x}) circulating in said first layer (2A).

8. A method as claimed in claim 1, further including the step of:
powering the second layer (2B) with said voltage value (Vcc), while said first layer (2A) is touched at said first point (P1) and said second point (P2) respectively;
detecting a second value of current (I_{2,y}) circulating in said second layer (2B), when the latter is powered with said voltage value;
processing said second detected current value (I_{2,y}) to calculate a second value (Δy) that represents the coordinate difference of the distance between the coordinates of said first touch point (P1) and said second touch point (P2), said coordinate difference being calculated along an axis (2D) of the second layer (2B), which is orthogonal to said axis (2C) of the first layer (2A);
processing said second value (Δy) and the coordinates of said midpoint (P0x,P0y) to determine the coordinates of said first touch point (P1) and/or said second touch point (P2) along said second axis (2D) of said second layer (2B).

9. A method as claimed in claim 8, also including the step of checking whether said second current value (I_{2,y}) that has been detected is higher than a second predetermined current threshold (I_{thdy}).

10. A method as claimed in claim 9, wherein said second threshold (I_{thdy}) is equal to the value of the current that circulates in said second layer (2B), when said first layer (2A) is touched at said first point (P1) or second point (P2) only.

11. A method as claimed in claim 8, wherein said step of processing said second current value (I_{2,y}) to determine said second modulus value (Δy) comprises:
comparing said second current value (I_{2,y}) with a second plurality of predetermined values, each representing a coordinate difference of the distance between the coordinates of said first point (P1) and second point (P2) along said axis (2D) of the second layer (2B).

12. A method as claimed in claim 11, wherein the step of comparing the second current value (I_{2,y}) with a second plurality of predetermined values comprises the steps of:
converting the second current value (I_{2,y}) into a corresponding voltage value (V_{2,y});
processing said voltage value (V_{2,y}) to generate the coordinate difference (Δy) between the coordinates of the first touch point (P1) and the second touch point (P2) along said axis (2D) of the second layer (2B), which is orthogonal to said axis (2C) of the first layer (2A).

13. A method as claimed in claim 11, wherein said step of processing said second value (Δy) and the coordinates of said midpoint (P0x,P0y) to determine the coordinates of said first touch point (P1) and said second touch point (P2) along said axis (2D) of the second layer (2B) comprises the step of:
adding or subtracting the second value (Δy) to/from the coordinates of said midpoint (P0x,P0y) to determine the coordinates of said first touch point (P1) and said second touch point (P2) along said axis (2D) of the second layer (2B), the latter being orthogonal to said axis (2C) of the first layer (2A).

14. A method as claimed in claim 8, wherein said step of processing said second current value to determine said second modulus value comprises the calculation of the second modulus value by the following formula
Δy=a_{n,y}*Iⁿ_{2,y}+a_{n-1,y}*Iⁿ⁻¹_{2,y}+a_{n-2,y}*Iⁿ⁻²_{2,y}+ . . . a_{1,y}*I_{2,y}+a_{0,y}
where a_{n,y} . . . , a_{0,y} represent the physical, circuit and non-linearity parameters of the second layer (2B), whereas Iⁿ_{2,y}, . . . , I_{2,y} represent n-th powers of said second value of current (I_{2,y}) circulating in said second layer (2B).

15. A method for determining the pressure value at least at one touch point (P1, P2) on a resistive touch screen, such screen having a first layer (2A) and a second layer (2B) with a first axis (2C) and a second axis (2D) orthogonal to each other, being definable thereat, and wherein said first layer (2A) is designed to be touched, the method comprising the steps of:
touching the first layer (2A) at least at one point (P1, P2);
characterized in that it comprises the steps of:
alternately powering said first layer (2A) and said second layer (2B) with a predetermined voltage value (Vcc), while said first layer (2A) is touched at said at least one point (P1, P2);
detecting a first value of current (I_{2,x}) circulating in said first layer (2A), when the latter is powered with said predetermined voltage value (Vcc) and a second value of current (I_{2,y}) circulating in said second layer (2B), when the latter is powered with said predetermined voltage value (Vcc);
comparing said first current value (I_{2,x}) with a third plurality of predetermined values, each representing the value of pressure exerted on the surface that has been touched at said at least one point (P1, P2) along said axis (2C) of the first layer (2A);
comparing said second current value (I_{2,y}) with a fourth plurality of predetermined values, each representing the value of pressure exerted on the surface that has been touched at said at least one point (P1, P2) along another axis (2D) of the second layer (2A), orthogonal to said axis (2C) of the first layer (2A).

16. A multiple touch controller operably associated to a resistive touch screen having a plurality of resistance lines (X+, X−, Y+, Y−) comprising:
an Analog-to-Digital converter (4);
a driver stage (6) for driving said plurality of resistance lines (X+, X−, Y+, Y−);
a logic section (5) for supervising the operation of the driver stage (6), and characterized in that it comprises a current reading device (7) operably connected between the driver stage (6) and a fixed potential point (GND) to detect a current (I_{2,x},I_{2,y}) that alternately flows in one of said first layer (2A) and second layer (2B) when said screen is powered with a supply voltage (Vcc) and is touched at a first point (P1) at the same time as it is touched at a second point (P2).

17. A multiple touch controller as claimed in claim 16, wherein said current reading device (7) is in signal communication with said Analog-to-Digital converter (4).

18. A multiple touch controller as claimed in claim 16, comprising a processing block (8) and means for generating coordinates of a midpoint (P0x,P0y) relative to the coordinates of said first touch point (P1) and said second touch point (P2), said processing block (8) being able to receive the values from the output of the Analog-to-Digital converter (4) and being able to process the values from the output of said Analog-to-Digital converter (4) and said coordinates of said midpoint (P0x,P0y) to generate the values representative of the coordinates of said first touch point (P1) and said second touch point (P2).

19. A multiple touch controller as claimed in claim 18, wherein said processing block (8) comprises at least one summer node (8A, 8B) for performing addition and/or subtraction of said first modulus value and/or said second modulus value (Δx, Δy) to/from said coordinates of said midpoint (P0).

20. A multiple touch controller as claimed in claim 16, wherein said current reading device (7) is implemented as a low-side current-to-voltage converter.

21. A multiple touch controller as claimed in claim 16, wherein said current reading device (7) is implemented as a high-side current-to-voltage converter.
